(19) United States
(12) Patent Application Publication
(10) Pub. No.: US 2003/0228775 A1
(43) Pub. Date: Dec. 11, 2003

(54) Device for electrically connecting contact points on neighboring circuit boards

(76) Inventors: Juergen Feye-Hohmann, Detmold (DE); Ralf Beckmann, Detmold (DE)

Correspondence Address: CHARLES E. BAXLEY, ESQ., 59 JOHN STREET, FIFTH FLOOR, NEW YORK, NY, 10038, US

(21) Appl. No.: 10/427,678

(22) Filed: May 1, 2003

(30) Foreign Application Priority Data
Jun. 5, 2002 (DE) DE 102 24 841.9

(51) Int. Cl. H01R 12/00

(52) U.S. Cl. 439/75

(57) ABSTRACT

Such a device is used for electrically connecting at least one contact point on a first circuit board to at least one contact point on a second circuit board positioned neighboring the first circuit board using at least one conductor provided with an insulating sheath. In order to be able to construct and handle such a device simply, it is distinguished by cutting contacts, to be positioned fixed on the relevant circuit board at the contact points, having cutters implemented at contact points for contacting the conductor without stripping and by a housing which receives the conductor and tightly encloses it, having a conductor insertion opening on the long side, which extends over the respective conductor length, and guide contours on both sides on the inner sides adjoining the conductor insertion opening, which run transversely to the housing lengthwise direction, which are recessed relative to lateral conductor bearing surfaces on these housing inner sides and which are tailored to a recess of the contact legs, which are provided with the cutters, of the cutting contacts.

The present invention relates to a device of the type specified in more detail in the preamble of claim 1.

Circuit board connectors, which are metal molded parts, exist for electrically connecting a contact point on a first circuit board to a contact point on a second circuit board. If the contact points to be electrically connected are positioned on circuit boards which are at an angle to one another, the circuit board connectors are prepared in cross-section at the region provided for the necessary angling in such a way that they may assume the angle by bending after attachment on one plate for connection to the contact point on the second plate.

The present intention is based on the object of providing a device of the type initially cited which is not only simply constructed, but is also simple to handle.

This object is achieved according to the present invention for a device having the features according to the species by the characterizing features of claim 1.

It is significant for the present invention that a simple sheathed conductor, which is easily available, unlike a metal molded part, is used for the electrical connection of the contact points on the circuit boards. The cutting contacts provided for contacting the sheathed conductor are soldered at the solder points of the conductors of the circuit board. This is preferably performed after the components of the circuit board are equipped, so that the circuit board may be pushed over a solder wave afterward. On the other hand, there is also the possibility of pressing the cutting contacts into the circuit board. However, care must be taken that the cutting contacts to be connected to one another via the conductor are aligned with the housing which accommodates the conductor. This applies above all if two or more cutting contacts are provided for each circuit board, which may be expedient, depending on the power load. The relevant conductor is either laid on the cutting contact or laid in the housing, and the housing is then pulled over the cutting contacts, the contact legs of the cutting contacts being received in the inside guide contours of the housing and the conductor being pushed onto the cutting contacts until the final position of the cutting contacts inside the housing is reached in such a way that the electrical contact is produced while cutting through the insulating sheath of the conductor. This also functions if the cutting contacts to be connected to one another are positioned on circuit boards at an angle to one another, typically at a right angle to one another. A housing which may be angled is then provided.

Advantageous features of the embodiment of the present invention result from the subclaims.

The present invention is described in further detail in the following on the basis of the drawing of an exemplary embodiment.

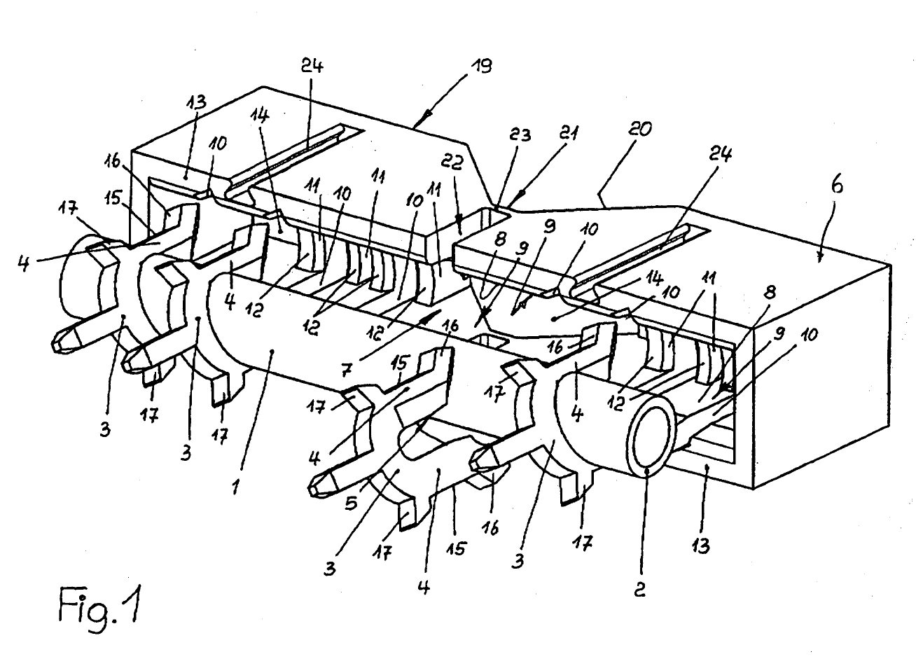

FIG. 1 shows a perspective illustration of a device for connecting contact points of two circuit boards,

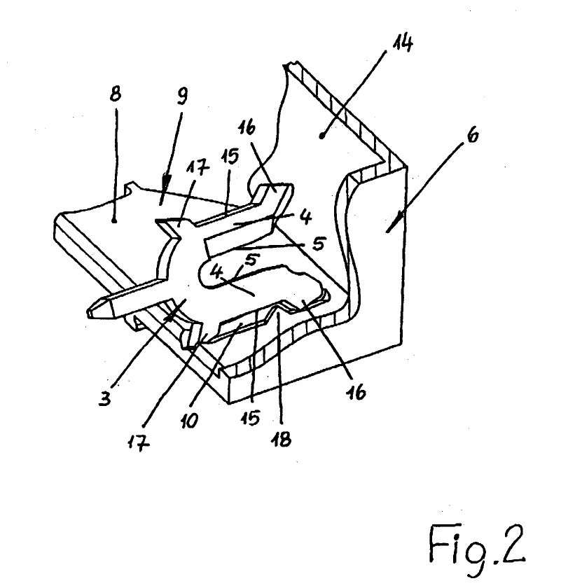

FIG. 2 shows a detail of the device shown in FIG. 1 in a perspective view,

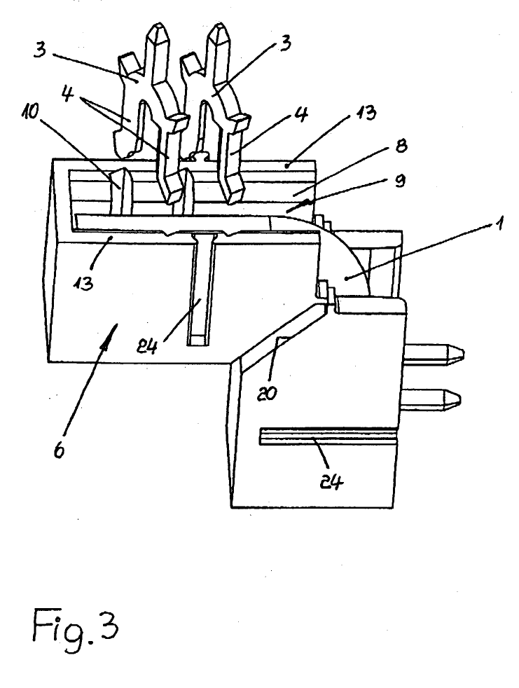

FIG. 3 shows a perspective illustration of the device shown in FIG. 1 in a position angled by 90 degrees, and

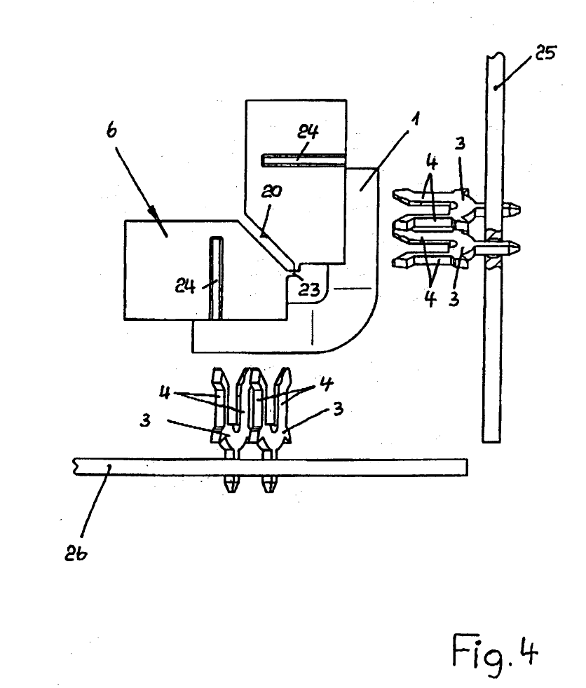

FIG. 4 shows a schematic top view of the angled device from FIG. 3 with an illustration of two circuit boards at an angle to one another.

In detail, FIG. 1 shows an electrical conductor 1, which has a typical metal core, which is enclosed by an insulating sheath 2. Using cutting contacts 3, the metal core of the conductor 1 may be contacted without stripping, and cutting contacts 3 are used for this purpose, each having two contact legs 4, which are positioned opposite to one another and essentially parallel and which have cutters 5 on their sides which face one another, which cut through the insulating sheath 2 when the conductor 1 is pushed between the contact legs 4. Two of the cutting contacts 3 at a time are positioned on a circuit board in the exemplary embodiment and soldered in there or pressed in to form a contact. In this case, the insertion openings are between the contact legs 4 of the cutting contacts 3 in an alignment corresponding to the alignment of the conductor 1 to be contacted.

A housing 6, which may be pushed onto the cutting contacts 3, is provided for receiving the conductor 1, including the cutting contacts 3. This is performed after the conductor 1 is either laid on the openings between the contact legs 4 of the cutting contacts 3 or is inserted into the housing 6. The relative displacement between the conductor 1 and the cutters 5 at the contact legs 4 of the cutting contacts 3, through which—as described—the contact is produced, occurs when the housing 6 is pushed onto the cutting contacts 3.

The housing 6 preferably has an inner length which corresponds to the length of the conductor 1. For insertion of the conductor 1 and the cutting contacts 3, the oblong housing 6 has an insertion opening 7 on its long side which is adjoined by diametrically opposing inner sides 8 of lateral walls 13 of the housing 6. The inner sides 8 of the housing lateral walls 13 at least partially form conductor support surfaces 9, whose distance to one another is essentially equal to the diameter of the conductor 1. Guide contours 10, like inset grooves for the conductor 1, which extend transversely to the lengthwise direction of the housing 6 and therefore in the insertion direction of the conductor 1 and the cutting contacts 3, are implemented on the housing inner sides 8 at these support surfaces 9 on both sides. The guide contours 10 are thus used to receive the cutting contacts 3, whose contact legs 4 have an envelope contour with a square or rectangular shape. At the outer edges 15 of the contact legs 4 of the cutting contacts 3, a locking tab 16 projects between the contact legs 4 near the insertion opening, and a further tab 17 projects outward near the rear connection bridge. When the housing 6 is pushed onto the cutting contacts 3, their locking tabs 16 and tabs 17 are guided in the guide contours 10 on the housing inner sides 8 and these guide contours 10 are implemented here as V-shaped grooves. In order that the housing 6 and the cutting contacts 3 may be locked with one another, a locking step 18 is located near the inner end in the guide contours 10, behind which the locking tab 16 on the outer side of the contact legs 4 of the cutting contacts 3 may snap in, as illustrated in FIG. 2.

In the inside of the housing, support ribs or webs 11 project in the direction toward the insertion opening 7 at the side of the housing 6 opposite the insertion side 7. The faces of the support webs 11 form conductor support surfaces 12, which are positioned toward the conductor insertion opening 7 and against which the conductor 1 pushed into the housing 6 comes to rest. In order that the desired relative displacement between the cutting contacts 3 and the conductor 1, which only begins upon joining, occurs as soon as the conductor 1 has come to rest on the conductor support surfaces 12 of the support webs 11, the guide contours 10 on the housing inner sides 8 extend away from the insertion opening 7 in the depth direction of the housing 6 over the conductor support surfaces 12 of the support webs 11. Thus, in the assembled arrangement, when the conductor 1 rests on the conductor support surfaces 12 of the support webs 11, the projecting locking tabs 16 of the contact legs 4 of the cutting contacts 3 extend almost up to a rear wall 14 of the housing, which may be provided for both stability and insulation reasons. The entire housing 6 is made of an insulating plastic.

Furthermore, an indentation or recess 20, which is a V-shaped groove extending over the entire width of the housing 6, may be seen in FIG. 1, shaped into the rear side 19 of the housing 6 opposite the insertion side 7. The recess 20, which accordingly runs transversely to the lengthwise direction of the housing 6, follows the rear wall 14 possibly positioned on the rear side 19 of the housing 6. In the same way, the lateral walls 13 of the housing 6 have the contour of the recess 20, whose sides are at an angle of 90 degrees to one another in the present case. The recess 20 has a flattened crown 21, which adjoins a flexible web 23, which is shaped into the plastic material of the housing 6 in one piece. In an extension of the plane of symmetry of the recess 20 running in the transverse direction to the housing 6, there is a slot 22 in the region of each of the lateral walls 13, which extends from the insertion side 7 of the housing 6 out in the transverse housing direction and up to the flexible web 23.

FIGS. 3 and 4 illustrate that the housing 6 may be angled by 90 degrees or possibly by another angle, the flexible web 23, which is formed by a part of the rear wall 14, functioning like a film hinge. Like the housing 6, the conductor 1, which is flexible anyway, may be angled in the same way and, as illustrated in FIG. 4, contact points, which are positioned on two circuit boards 25 and 26 which are at an angle to one another and, in the present case, enclose an angle of 90 degrees with one another, may thus be connected to one another.

In a variation of the drawing, for a data connection between two circuit boards, it may be sufficient to provide each circuit board with only one single cutting contact 3. For power connections between the circuit boards, for which larger conductor cross-sections are typically provided, the power may be transmitted on multiple cutting contacts 3, for which two cutting contacts 3 are present on each circuit board in the exemplary embodiment illustrated.

The folding or angling point of the housing 6, which is predetermined by the position of the recess 20 and the slot 22, may also be provided in a place other than the transverse center of the housing 6. For example, the housing 6 may be angled if one section of the housing 6, including the conductor 1, is already locked onto the cutting contacts 3 of one circuit board, after which the other housing section is then angled, while taking along the conductor 1, and pulled over the relevant cutting contact 3 of the second circuit board. In this case, the entire device may be provided with elasticity such that the tabs 16 and 17 of the cutting contacts 3 are located in the guide contours 10 on the housing inner sides 8.

Tongue and groove elements 24 are shaped onto the outer sides of the lateral walls 13 of the housing 6 in the transverse direction of the housing, which are used for a mechanical connection of a housing 6 to a second housing 6, if two or more connections of the present type are providing lying next to one another in parallel.

1. A device for electrically connecting at least one contact point on a first circuit board to at least one contact point on a second circuit board, positioned neighboring the first circuit board, using at least one conductor (1) which is provided with an insulating sheath (2),
characterized by
cutting contacts (3), to be positioned fixed at the contact points on the relevant circuit board, having cutters (5) implemented at contact points (4) for contacting the conductor (1) without stripping, and by a housing (6), which receives the conductor (1) and tightly encloses it, having a conductor insertion opening (7) on the long side, which extends over the respective conductor length, and guide contours (10) on both sides on the inner sides (8) adjoining the conductor insertion opening (7), which run transversely to the housing lengthwise direction, which are recessed relative to lateral conductor bearing surfaces (9) on these housing inner sides (8) and which are tailored to a recess of the contact legs (4) of the cutting contacts (3), which are provided with the cutters (5).

2. The device according to claim 1,
characterized in that
support webs (11) for supporting the conductor (1), whose conductor support surfaces (12) project in the direction toward the conductor insertion opening (7) over the inner end regions of the guide contours (10) for the contact legs (4) of the cutting contacts (3), are positioned on the inner side of the housing (6) lying opposite the conductor insertion opening (7) in the depth direction.

3. The device according to claim 1 or 2,
characterized in that
the guide contours (10) positioned on opposite housing inner sides (8) are parallel to one another.

4. The device according to claim 3,
characterized in that
the housing (6) is U-shaped in cross-section and correspondingly has lateral walls (13), which are parallel to one another, having the inside guide contours (10) thereon and a rear wall (14), which is perpendicular to the lateral walls (13), opposite the conductor insertion opening (7).

5. The device according to claim 3 or 4,
characterized in that
the two contact legs (4) of each cutting contact (3) have a shared square or rectangular envelope shape.

6. The device according to claim 5,
characterized in that
the outer edges (15) of the contact legs (4) of the cutting contacts (3) may be received in the join direction in a press fit in the guide contours (10) on the opposing housing inner sides (8).

7. The device according to claim 5 or 6,
characterized in that
the outer edges (15) of the contact legs (4) of the cutting contacts (3), which lie in the join direction, have tabs (16, 17) projecting outward which may be received in the guide contours (10) on the opposing housing inner sides (8).

8. The device according to claim 7,
characterized in that
at least one of the tabs (16, 17) is implemented as a locking tab on the outer edges (15) of the contact legs (4) of the cutting contacts (3) and locking steps (18) which work together with the locking tabs (17) are positioned in the guide contours (10) on the opposing housing inner sides (8).

9. The device according to one of claims 4-8,
characterized in that
the housing (6) has at least one angled recess (20) on the side furthest from the conductor insertion opening (7), whose crown (21) extends over the width of the housing and from the back side (19) up into both lateral walls (13), and a slot (22) lying centrally thereto in the lateral walls (13), which extends from the conductor insertion opening (7) into the lateral walls (13) up to near the crown (21) of the recess (20) to form a residual, flexible web (23).

10. The device according to one of claims 4-9,
characterized in that
the housing (6) has undercut tongue and groove elements (24) on the outer sides of its lateral walls (13), running in the depth direction, for mechanical connection to a neighboring housing (6) having identical coupling elements (24).
